(19) United States
(12) Patent Application Publication
(10) Pub. No.: US 2026/0077589 A1
(43) Pub. Date: Mar. 19, 2026

(54) Method For Detecting Temperature Of Head Chip, And Liquid Ejecting Apparatus

(71) Applicant: SEIKO EPSON CORPORATION, Tokyo (JP)

(72) Inventor: Tomohiro MATSUBAYASHI, Matsumoto (JP)

(21) Appl. No.: 19/331,349

(22) Filed: Sep. 17, 2025

(30) Foreign Application Priority Data
Sep. 18, 2024 (JP) 2024-160853

(51) Int. Cl. B41J 2/045

(52) U.S. Cl. CPC B41J 2/04563; B41J 2/04581; B41J 2/04588; B41J 2/04596

(57) ABSTRACT

The present disclosure provides a method for detecting a temperature of a head chip including a plurality of nozzles for ejecting liquid, a plurality of piezoelectric elements that is configured to apply pressure to the liquid in order to eject the liquid from the plurality of nozzles, and a temperature detection element. This method includes detecting the temperature of the head chip using the temperature detection element during a minute vibration application period in which a minute vibration waveform, which does not cause liquid to be ejected from the plurality of nozzles, is applied to the plurality of piezoelectric elements. The detecting the temperature includes generating the minute vibration waveform such that the minute vibration waveform includes a first waveform having a predefined voltage change and a second waveform that is an inverted waveform of the first waveform.

The present application is based on, and claims priority from JP Application Ser. No 2024-160853, filed Sep. 18, 2024, the disclosure of which is hereby incorporated by reference herein in its entirety.

### BACKGROUND

### 1. Technical Field

The present disclosure relates to a method for detecting the temperature of a head chip, and a liquid ejecting apparatus.

### 2. Related Art

JP-A-2022-124599 discloses a liquid ejecting head including nozzles for ejecting liquid, a pressure chamber communicating with the nozzles, a piezoelectric element for changing the liquid pressure in the pressure chamber, and a resistance wire for detecting the temperature of the pressure chamber.

However, in the related art mentioned above, there is an issue in that noise caused by a drive signal for driving the piezoelectric element is superimposed on a temperature detection signal, which causes a decrease in detection accuracy.

### SUMMARY

According to a first aspect of the present disclosure, there is provided a method for detecting a temperature of a head chip including a plurality of nozzles for ejecting liquid, a plurality of piezoelectric elements for applying pressure to the liquid in order to eject the liquid from each of the plurality of nozzles, and a temperature detection element. The method includes detecting the temperature of the head chip using the temperature detection element during a minute vibration application period in which a minute vibration waveform is applied to the plurality of piezoelectric elements. The minute vibration waveform does not cause the liquid to be ejected from the plurality of nozzles. The detecting the temperature includes generating the minute vibration waveform such that the minute vibration waveform includes a first waveform having a predefined voltage change and a second waveform that is an inverted waveform of the first waveform.

According to a second aspect of the present disclosure, there is provided a liquid ejecting apparatus that ejects liquid. The liquid ejecting apparatus includes: a head chip including a plurality of nozzles configured to eject the liquid, a plurality of piezoelectric elements configured to apply pressure to the liquid in order to eject the liquid from each of the plurality of nozzles, and a temperature detection element; a drive signal generator configured to generate a minute vibration waveform that does not cause the liquid to be ejected from the plurality of nozzles; a drive circuit configured to apply the minute vibration waveform to the plurality of piezoelectric elements in a minute vibration application period; and a temperature detection circuit configured to detect a temperature of the head chip using the temperature detection element during the minute vibration application period. The drive signal generator is configured to generate the minute vibration waveform such that the minute vibration waveform includes a first waveform having a predefined voltage change and a second waveform that is an inverted waveform of the first waveform.

According to a third aspect of the present disclosure, there is provided a method for detecting a temperature of a head chip including a plurality of nozzles for ejecting liquid, a plurality of piezoelectric elements for applying pressure to the liquid in order to eject the liquid from each of the plurality of nozzles, and a temperature detection element. The method includes detecting the temperature of the head chip using the temperature detection element during a minute vibration application period in which a minute vibration waveform is applied to the plurality of piezoelectric elements. The minute vibration waveform does not cause the liquid to be ejected from the plurality of nozzles. The detecting the temperature includes generating the minute vibration waveform such that the minute vibration waveform includes a first waveform having a predefined voltage change and a second waveform different from the first waveform. The first waveform and the second waveform are formed such that an error in a detection result of the temperature detection element caused by a potential change of the temperature detection element due to a potential change of the first waveform is reduced by a potential change of the temperature detection element due to a potential change of the second waveform.

According to a fourth aspect of the present disclosure, there is provided a liquid ejecting apparatus that ejects liquid. The liquid ejecting apparatus includes: a head chip including a plurality of nozzles configured to eject the liquid, a plurality of piezoelectric elements configured to apply pressure to the liquid in order to eject the liquid from each of the plurality of nozzles, and a temperature detection element; a drive signal generator configured to generate a minute vibration waveform that does not cause the liquid to be ejected from the plurality of nozzles; a drive circuit configured to apply the minute vibration waveform to the plurality of piezoelectric elements in a minute vibration application period; and a temperature detection circuit configured to detect a temperature of the head chip using the temperature detection element during the minute vibration application period. The drive signal generator is configured to generate the minute vibration waveform such that the minute vibration waveform includes a first waveform having a predefined voltage change and a second waveform different from the first waveform The first waveform and the second waveform are formed such that an error in a detection result of the temperature detection element due to a potential change of the temperature detection element caused by a potential change of the first waveform is reduced by a potential change of the temperature detection element due to a potential change of the second waveform.

### BRIEF DESCRIPTION OF THE DRAWINGS

FIG. 1 is an explanatory diagram illustrating a configuration of a liquid ejecting apparatus according to an embodiment.

FIG. 2 is a functional block diagram of a controller and a liquid ejecting head.

FIG. 3 is an explanatory diagram illustrating an arrangement of nozzle rows and temperature detection elements.

FIG. 4 is a sectional view of a head chip.

FIG. 5 is a conceptual diagram of the liquid ejecting head in a first embodiment.

FIG. 6 is a timing chart illustrating a temperature detection method according to the first embodiment.

FIG. 7 is an explanatory diagram illustrating another example of a minute vibration waveform according to the first embodiment.

FIG. 8 is an explanatory diagram illustrating yet another example of the minute vibration waveform according to the first embodiment.

FIG. 9 is an explanatory diagram illustrating a minute vibration waveform according to a second embodiment.

FIG. 10 is a conceptual diagram of a liquid ejecting head in a third embodiment.

FIG. 11 is a timing chart illustrating a temperature detection method according to the third embodiment.

FIG. 12 is a timing chart illustrating a temperature detection method according to a fourth embodiment.

### DESCRIPTION OF EMBODIMENTS

### A. First Embodiment

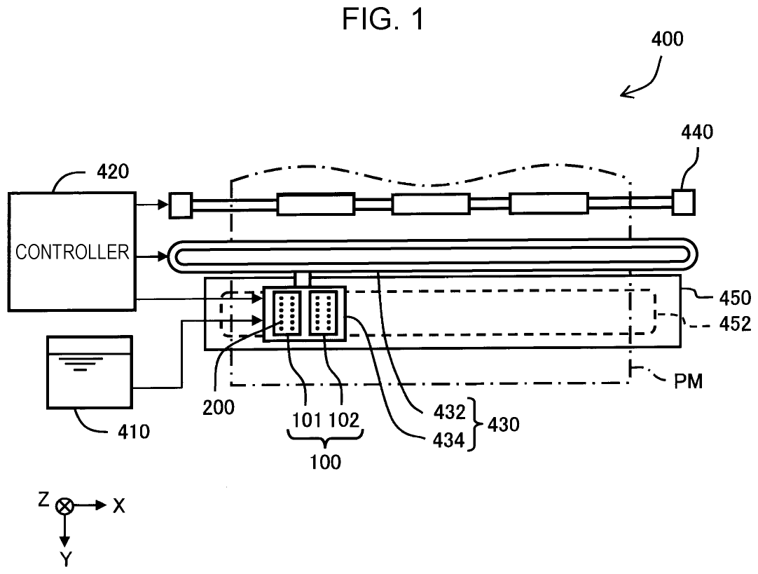

FIG. 1 is an explanatory diagram illustrating a configuration of a liquid ejecting apparatus 400 according to an embodiment. The liquid ejecting apparatus 400 is an ink jet printing apparatus that ejects ink, which is an exemplary liquid, onto a medium PM. A liquid reservoir 410 for storing ink can be attached to the liquid ejecting apparatus 400. The liquid ejecting apparatus 400 performs printing by ejecting ink from the liquid reservoir 410 toward the medium PM. The liquid ejecting apparatus 400 includes a liquid ejecting head 100, a controller 420, a movement mechanism 430, a transport mechanism 440, and a platen 450.

The liquid ejecting head 100 includes two head chips 101 and 102. However, the liquid ejecting head 100 may be structured to include any number of head chips. Each of the head chips 101 and 102 includes a plurality of nozzles 200 and ejects liquid ink supplied from the liquid reservoir 410 through the plurality of nozzles 200. Specific forms of the liquid reservoir 410 include, for example, a cartridge attachable to and detachable from the liquid ejecting apparatus 400, a bag-shaped ink pack formed of a flexible film, and a container such as an ink tank capable of being refilled with ink. The ink ejected from the nozzles 200 lands on the medium PM. The medium PM is typically a sheet of printing paper. The medium PM is not limited to a sheet of printing paper and may, for example, be a printing target made of any material such as a resin film or fabric.

The composition of the ink is not particularly limited and may be, for example, a water-based ink in which a coloring material such as a dye or a pigment is dissolved in a water-based solvent, a solvent-based ink in which a coloring material is dissolved in an organic solvent, or an ultraviolet (UV) curable ink. In addition, the liquid ejecting apparatus 400 may eject another type of liquid, such as paint, instead of ink.

The movement mechanism 430 includes a ring-shaped belt 432 and a carriage 434 fixed to the belt 432. The carriage 434 holds the liquid ejecting head 100. The movement mechanism 430 can cause the liquid ejecting head 100 to reciprocate in the X direction by bidirectionally rotating the ring-shaped belt 432.

The transport mechanism 440 transports the medium PM in the Y direction during intervals between movements of the liquid ejecting head 100 by the movement mechanism 430. The Y direction is a direction perpendicular to the X direction. In the present embodiment, the X and Y directions are horizontal. The Z direction intersects the X and Y directions. In the present embodiment, the Z direction is vertically downward. The liquid ejecting head 100 ejects liquid in the Z direction while being transported in the X direction. The Z direction is also referred to as an “ejection direction”.

The platen 450 is a supporting unit that supports the medium PM on which the liquid ejected from the liquid ejecting head 100 lands. The platen 450 is provided with a platen heater 452. The platen heater 452 can heat the platen 450 to promote drying of the liquid on the medium PM.

The controller 420 controls the operation of ejecting liquid from the liquid ejecting head 100. The controller 420 controls the movement mechanism 430, the transport mechanism 440, and the liquid ejecting head 100 to form an image on the medium PM.

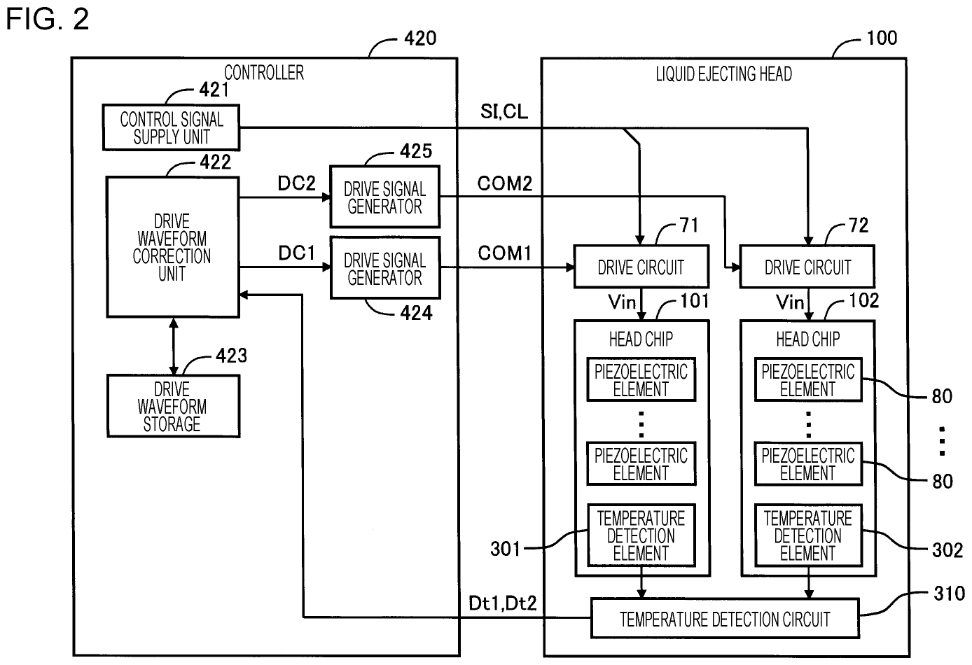

FIG. 2 is a functional block diagram of the controller 420 and the liquid ejecting head 100. FIG. 2 illustrates portions related to the temperature detection of the head chips 101 and 102 and the temperature correction of drive signals.

The controller 420 includes a control signal supply unit 421, a drive waveform correction unit 422, a drive waveform storage 423, and drive signal generators 424 and 425.

The controller 420 may be implemented by a computer including a processor and a memory. The functions of the control signal supply unit 421 and the drive waveform correction unit 422 can be implemented by the processor executing a computer program stored in the memory. However, some or all of these functions may instead be implemented by a hardware circuit.

The control signal supply unit 421 supplies various control signals, including a dot control signal SI and a dot clock signal CL, to the drive circuits 71 and 72 of the liquid ejecting head 100. The dot control signal SI indicates whether a dot is to be formed or not on the medium PM and the dot size and is also referred to as a print signal. The waveform of a drive signal Vin, which drives piezoelectric elements 80 in order to eject the liquid from individual nozzles 200, is determined according to the dot control signal SI. The dot clock signal CL defines a dot period.

The drive waveform correction unit 422 corrects drive waveform data DC1 and DC2, which represent the waveforms of the common drive signals COM1 and COM2, respectively, in accordance with the detected temperatures of the head chips 101 and 102. Correction data corresponding to the detected temperatures of the head chips 101 and 102 is stored in advance in the drive waveform storage 423. The drive waveform correction unit 422 reads first correction data from the drive waveform storage 423 in accordance with the detected temperature of the first head chip 101, and corrects the drive waveform data DC1 for the first common drive signal COM1 according to the first correction data. The drive waveform correction unit 422 also reads second correction data from the drive waveform storage 423 in accordance with the detected temperature of the second head chip 102, and corrects the drive waveform data DC2 for the second common drive signal COM2 according to the second correction data.

The drive waveform data DC1 and DC2 may be corrected according to the average of the two detected temperature values of the head chips 101 and 102. When temperature detection elements 301 and 302 are resistance temperature detectors, the drive waveform data DC1 and DC2 may be corrected according to the average of the current values output from the first temperature detection element 301 and the second temperature detection element 302.

The drive signal generators 424 and 425 generate the common drive signals COM1 and COM2 using the temperature-corrected drive waveform data DC1 and DC2, respectively. The common drive signals COM1 and COM2 are applied to a plurality of piezoelectric elements 80 in common. In the first embodiment, the first common drive signal COM1 is applied to the plurality of piezoelectric elements 80 of the first head chip 101 in common, and the second common drive signal COM2 is applied to the plurality of piezoelectric elements 80 of the second head chip 102 in common.

The liquid ejecting head 100 includes the drive circuit 71 for the first head chip 101, the drive circuit 72 for the second head chip 102, and a temperature detection circuit 310.

The first head chip 101 includes the plurality of piezoelectric elements 80, which apply pressure to the liquid in order to eject the liquid from the plurality of nozzles 200, and the temperature detection element 301 for detecting the temperature of the first head chip 101. Similarly, the second head chip 102 includes a plurality of piezoelectric elements 80 and the temperature detection element 302.

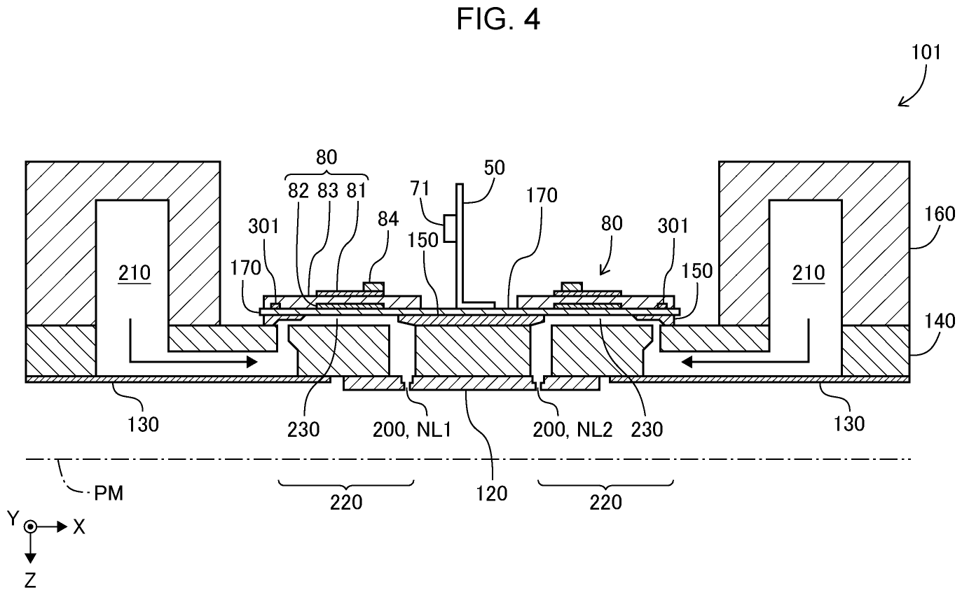

The drive circuit 71 for the first head chip 101 generates the drive signals Vin for driving the individual piezoelectric elements 80 in the first head chip 101, based on the first common drive signal COM1 and the dot control signal SI. Specifically, for each dot period defined by the dot clock signal CL, the drive circuit 71 generates the drive signal Vin, which includes part or all of the waveform of the first common drive signal COM1, according to the dot control signal SI. For example, when the first head chip 101 includes 100 piezoelectric elements 80, 100 drive signals Vin are individually generated. The generation of the drive signal Vin for each piezoelectric element 80 by the drive circuit 71 may be implemented using, for example, the supply circuit 31 illustrated in FIG. 4 of JP-A-2023-31984, disclosed by the applicant of the present disclosure. The same applies to the drive circuit 72 for the second head chip 102.

The temperature detection circuit 310 uses the temperature detection element 301 to generate a temperature detection signal Dt1 indicating the temperature of the first head chip 101. The temperature detection circuit 310 also uses the temperature detection element 302 to generate a temperature detection signal Dt2 indicating the temperature of the second head chip 102. The temperature detection signals Dt1 and Dt2 are supplied to the drive waveform correction unit 422 of the controller 420.

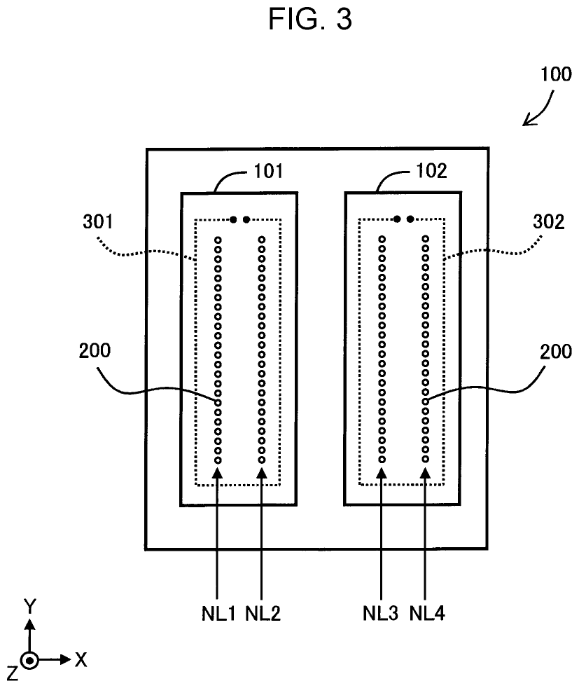

FIG. 3 is an explanatory diagram illustrating an arrangement of nozzle rows and temperature detection elements. The first head chip 101 includes two nozzle rows NL1 and NL2, and the second head chip 102 includes two nozzle rows NL3 and NL4. In each of the nozzle rows NL1 to NL4, the nozzles 200 are arranged in the Y direction. The temperature detection element 301 of the first head chip 101 is disposed to surround the outer periphery of the two nozzle rows NL1 and NL2 of the first head chip 101. Similarly, the temperature detection element 302 of the second head chip 102 is disposed to surround the outer periphery of the two nozzle rows NL3 and NL4 of the second head chip 102. However, various arrangements other than this are also possible for the temperature detection elements 301 and 302. In the present embodiment, a resistance temperature detector is used as each of the temperature detection elements 301 and 302. However, other types of temperature sensors, such as thermistors, thermocouples, or IC temperature sensors, may be used as the temperature detection elements 301 and 302. A resistance temperature detector is advantageous in that it can detect the average temperature of the region in which it is placed.

FIG. 4 is a sectional view of the head chip 101. The head chip 101 includes common liquid chambers 210, which receive liquid from an external source, and nozzle-specific flow paths 220, each connecting the common liquid chamber 210 to an individual nozzle 200. Each common liquid chamber 210 is shared by a plurality of nozzles 200 that constitute one nozzle row. That is, the common liquid chamber 210 temporarily stores liquid supplied from the liquid reservoir 410 and distributes it to the plurality of nozzle-specific flow paths 220 corresponding to the plurality of nozzles 200. In FIG. 4, the nozzle-specific flow paths 220 for the nozzles 200 of the first and second nozzle rows NL1 and NL2 have the same structure.

Each nozzle-specific flow path 220 includes a pressure chamber 230 that applies pressure to the liquid.

The piezoelectric element 80, which changes the volume of the pressure chamber 230, is placed for the pressure chamber 230.

The common liquid chamber 210 and the plurality of nozzle-specific flow paths 220 are mainly formed by a communication plate 140 and a pressure chamber substrate 150. The communication plate 140 is a laminated structure composed of a plurality of plate-like members. A housing portion 160 and the pressure chamber substrate 150 are placed on the upper surface of the communication plate 140. The pressure chamber substrate 150 is located inside the housing portion 160 when viewed in plan in the Z direction. A diaphragm 170 is placed on the upper surface of the pressure chamber substrate 150. The pressure chamber 230 is a space defined by the communication plate 140, the diaphragm 170, and the pressure chamber substrate 150. The pressure chamber substrate 150 is formed, for example, by processing a single-crystal silicon substrate using a semiconductor processing technique. The communication plate 140 can also be formed by stacking a plurality of single-crystal silicon substrates.

A nozzle plate 120 is placed on the lower surface of the communication plate 140. A lower end portion of the common liquid chamber 210 is sealed with a flexible sealing film 130, which may be made of a resin film, a thin metallic film, or similar material.

The wiring substrate 50 is bonded to the upper surface of the diaphragm 170. The wiring substrate 50 is a mounting component on which a plurality of wiring lines are formed to electrically connect the controller 420 and the head chip 101. A drive circuit 71 for driving the piezoelectric elements 80 is mounted on the wiring substrate 50. When the piezoelectric elements 80 vibrate, the vibrations are transmitted to the corresponding pressure chambers 230, generating the liquid pressure in each pressure chamber 230. The liquid is ejected from the nozzle 200 by the pressure generated by the piezoelectric element 80. Each piezoelectric element 80 includes a first electrode 81, a second electrode 82, and a piezoelectric body 83 disposed between the first and second electrodes 81 and 82. The first electrode 81 is connected to a drive wiring line 84. A wiring line between the drive wiring line 84 and the drive circuit 71 is not illustrated in the drawing. The first electrode 81 is individually provided for each piezoelectric element 80. In contrast, a single second electrode 82 and a single piezoelectric body 83 are shared among the plurality of piezoelectric elements 80 that drive the nozzles 200 of one row.

A temperature detection element 301 is disposed in the vicinity of the piezoelectric element 80. Specifically, the temperature detection element 301 is located between the piezoelectric body 83 and the diaphragm 170. Additionally, as illustrated in FIG. 3, the temperature detection element 301 is disposed so as to surround the plurality of nozzles 200 when viewed in plan. Preferably, the temperature detection element 301 is a resistance temperature detector that includes a portion in contact with the piezoelectric body 83 of the piezoelectric element 80.

Since the temperature detection element 301 is disposed in the vicinity of the piezoelectric element 80, noise caused by a drive signal for the piezoelectric element 80 is likely to be superimposed on the temperature detection signal Dt1, reducing the detection accuracy. If the temperature detection element 301 includes a portion in contact with the piezoelectric body 83, this drive signal noise becomes even more significant. Therefore, in the present embodiment, as will be described later, a concept is introduced to reduce the effects of this drive signal noise on the detected temperature of the head chip 101.

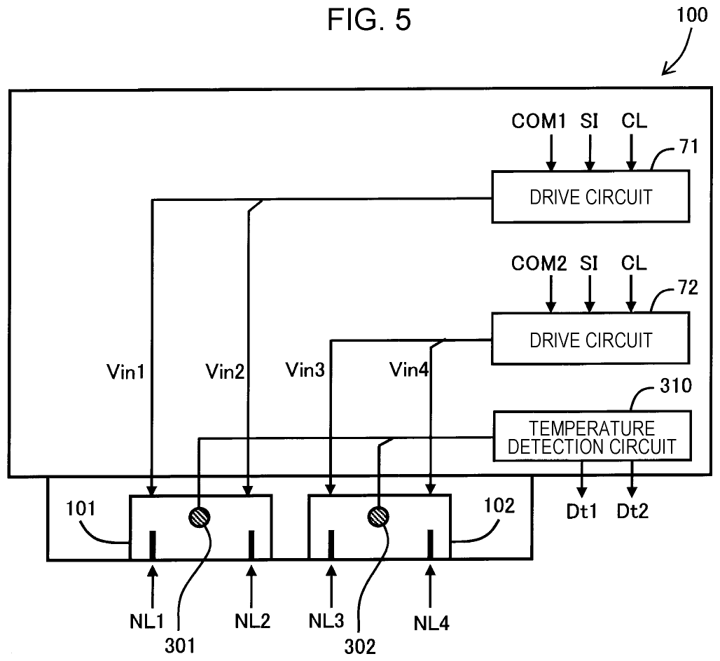

FIG. 5 is a conceptual diagram of the liquid ejecting head 100 in the first embodiment, in which the configuration in the first embodiment described with reference to FIGS. 1 to 4 is simplified. For each dot period defined by the dot clock signal CL, the drive circuit 71 for the first head chip 101 generates a drive signal Vin1, which is supplied to each piezoelectric element 80 of the first nozzle row NL1, and a drive signal Vin2, which is supplied to each piezoelectric element 80 of the second nozzle row NL2, based on the first common drive signal COM1 and the dot control signal SI. Similarly, for each dot period defined by the dot clock signal CL, the drive circuit 72 for the second head chip 102 generates a drive signal Vin3, which is supplied to each piezoelectric element 80 of the third nozzle row NL3, and a drive signal Vin4, which is supplied to each piezoelectric element 80 of the fourth nozzle row NL4, based on the second common drive signal COM2 and the dot control signal SI. The temperature detection circuit 310 uses the temperature detection element 301 to generate the temperature detection signal Dt1 indicating the detected temperature of the first head chip 101. The temperature detection circuit 310 also uses the temperature detection element 302 to generate the temperature detection signal Dt2 indicating the detected temperature of the second head chip 102.

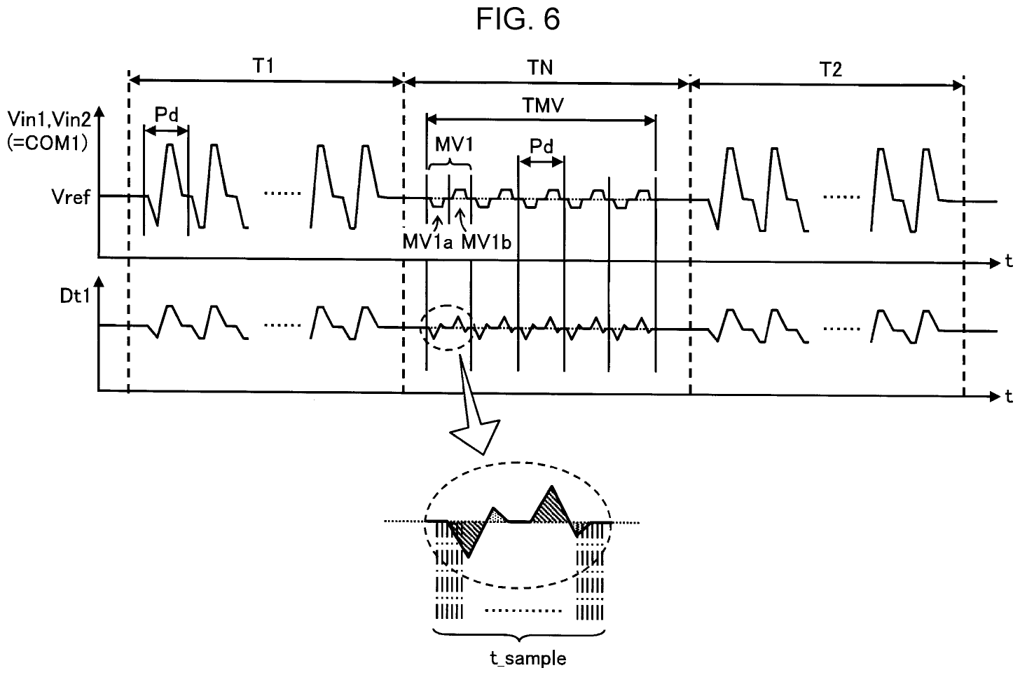

FIG. 6 is a timing chart illustrating a temperature detection method according to the first embodiment. The horizontal axis of FIG. 6 represents time t. The upper portion of FIG. 6 illustrates the drive signal Vin1 or Vin2 of the first head chip 101. In each dot period Pd, the drive signal Vin1 or Vin2 has a waveform selected from among the waveforms of the first common drive signal COM1. The lower portion of FIG. 6 illustrates the temperature detection signal Dt1 of the first head chip 101.

In FIG. 6, a first ejection period T1, a non-ejection period TN, and a second ejection period T2 are illustrated. During the first ejection period T1, the liquid ejecting head 100 ejects liquid from the nozzles 200 while moving at a constant speed in the X direction in FIG. 1.

During the second ejection period T2, the liquid ejecting head 100 ejects liquid from the nozzles 200 while moving at a constant speed in the-X direction, which is opposite to the X direction. The movement path of the liquid ejecting head 100 in the X direction is referred to as the “forward path”, and the movement path of the liquid ejecting head 100 in the-X direction is referred to as the “backward path”. The non-ejection period TN is a period in which the movement direction of the liquid ejecting head 100 is changed from the forward path to the backward path. Note that there is also a non-ejection period in which the movement direction of the liquid ejecting head 100 is changed from the backward path to the forward path, although this period is not illustrated in FIG. 6.

During the first ejection period T1 and the second ejection period T2, the drive signal Vin1 or Vin2, which has a waveform selected from among those of the first common drive signal COM1 and exhibits irregular potential changes for ejecting liquid from the nozzles 200, is applied to the piezoelectric element 80 in each dot period Pd. As a result, noise with the polarity biased to one side is generated in the temperature detection signal Dt1 due to the drive signal Vin1 or Vin2. Therefore, the temperature detection circuit 310 does not perform temperature detection during these ejection periods T1 and T2.

The non-ejection period TN includes a minute vibration period TMV. During the minute vibration period TMV, a minute vibration waveform MV1, selected from among the waveforms of the first common drive signal COM1, is applied to the piezoelectric elements 80 in each dot period Pd. The minute vibration waveform MV1 has a smaller amplitude than the drive waveform used for ejecting liquid from the nozzles 200, and does not cause liquid to be ejected from the nozzles 200. The minute vibration waveform MV1 is applied in order to prevent thickening of the liquid. In order to prevent thickening of the liquid, it is preferable that the minute vibration period TMV span substantially the entire non-ejection period TN. The “substantially the entire period” refers to 90% or more of the total duration. The drive signal including the minute vibration waveform MV1 is supplied to the first electrode 81 of the piezoelectric element 80.

In the first embodiment, the minute vibration waveform MV1 is generated to include a first waveform MV1a and a second waveform MV1b. The first waveform MV1a has a predefined voltage change, and the second waveform MV1b is an inverted waveform of the first waveform MV1a. The term “inverted waveform” broadly includes a waveform obtained by vertically inverting the voltage change with respect to a reference potential Vref, as well as a waveform obtained by further horizontally inverting the waveform. The reference potential Vref is a potential maintained for a predetermined period from the start of the common drive signal COM1 in each dot period Pd.

It is preferable that the waveform shape of the first waveform MV1a corresponding to a potential higher than or equal to the reference potential Vref and the waveform shape of the second waveform MV1b corresponding to a potential lower than or equal to the reference potential Vref be symmetrical with respect to the reference potential Vref. Likewise, it is preferable that the waveform shape of the first waveform MV1a corresponding to a potential lower than or equal to the reference potential Vref and the waveform shape of the second waveform MV1b corresponding to a potential higher than or equal to the reference potential Vref be symmetrical with respect to the reference potential Vref. Furthermore, it is preferable that the area enclosed by the reference potential Vref and the first waveform MV1a be equal to the area enclosed by the reference potential Vref and the second waveform MV1b.

In the example illustrated in FIG. 6, the first waveform MV1a changes from the reference potential Vref into a concave shape and returns to the reference potential Vref, while the second waveform MV1b changes from the reference potential Vref into a convex shape and returns to the reference potential Vref. In addition, the first waveform MV1a and the second waveform MV1b are generated such that they appear sequentially, with their changing portions not overlapping each other.

When the minute vibration waveform MV1 is applied, noise corresponding to the minute vibration waveform MV1 is generated in the temperature detection signal Dt1. However, because the minute vibration waveform MV1 is composed of the first waveform MV1a and the second waveform MV1b, which are inverted versions of each other, noise caused by the first waveform MV1a and noise caused by the second waveform MV1b are averaged and substantially cancel each other out. As illustrated in an enlarged manner at the bottom of FIG. 6, the temperature detection circuit 310 preferably performs temperature detection at a plurality of sampling timings t_sample, with a sufficiently short sampling interval to allow the noise to be averaged out. That is, it is preferable to set the plurality of sampling timings t_sample for temperature detection in each dot period Pd. As a result, the temperature of the first head chip 101 can be accurately detected. The temperature of the second head chip 102 is detected in the same manner.

The temperature detection described above may be performed within a single dot period Pd during which the minute vibration waveform MV1 is generated, or across a plurality of dot periods Pd. Additionally, the detection may be performed throughout the entire minute vibration period TMV. The operation of the liquid ejecting apparatus 400 during the period in which temperature detection is performed corresponds to the operation of “detecting temperature” in the present disclosure.

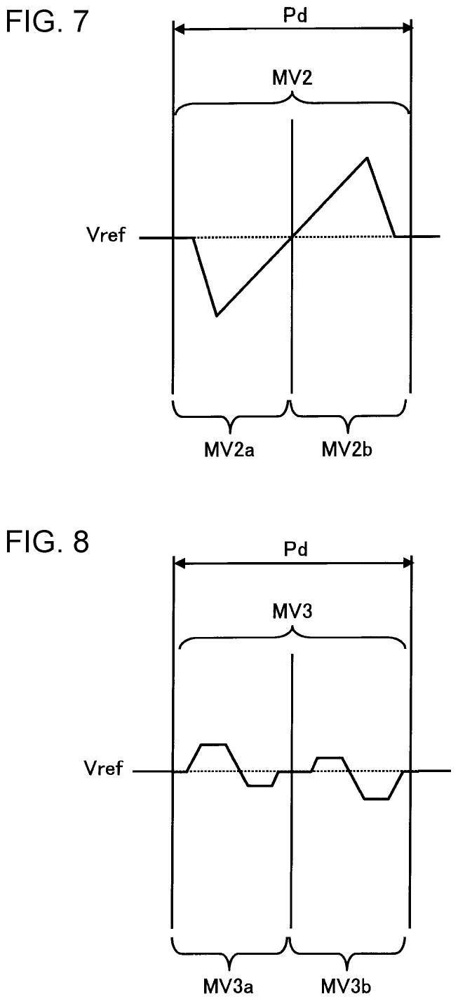

FIG. 7 is an explanatory diagram illustrating another example of the minute vibration waveform according to the first embodiment. The minute vibration waveform MV2 consists of a first waveform MV2a, having an inverted triangular shape that changes in a concave manner from the reference potential Vref, and a second waveform MV2b, obtained by vertically flipping the first waveform MV2a. The first waveform MV2a and the second waveform MV2b are generated such that they appear sequentially, with their changing portions not overlapping each other. Because the potential change of the second waveform MV2b follows immediately after the potential change of the first waveform MV2a, the minute vibration waveform MV2 can be regarded as a single waveform. The minute vibration waveform MV2 provides the same effects as the minute vibration waveform MV1 illustrated in FIG. 6.

FIG. 8 is an explanatory diagram illustrating yet another example of the minute vibration waveform according to the first embodiment. The minute vibration waveform MV3 consists of a first waveform MV3a having a predetermined change and a second waveform MV3b obtained by vertically and horizontally flipping the first waveform MV3a. Each of the first waveform MV3a and the second waveform MV3b includes a changing portion with a potential higher than the reference potential Vref and a changing portion with a potential lower than the reference potential Vref. The first waveform MV3a and the second waveform MV3b may be considered to be in a relationship of 180-degree rotational symmetry about a point on the straight line representing the reference potential Vref. The minute vibration waveform MV3 also provides the same effects as the minute vibration waveform MV1 illustrated in FIG. 6.

Although the waveforms of the common drive signals COM1 and COM2 are described above as being corrected in accordance with the detected temperatures of the head chips 101 and 102, the detected temperatures of the head chips 101 and 102 may be used for other purposes. For example, the temperature adjustment using the platen heater 452 may be performed in accordance with the detected temperatures of the head chips 101 and 102. In such a case, the temperature adjustment may be performed in accordance with the average value of the detected temperatures of the head chips 101 and 102, or the temperature adjustment may be performed in accordance with the maximum value or the minimum value of the detected temperatures within a certain period.

In the first embodiment described above, the temperature is detected using the temperature detection element 301 while a minute vibration waveform composed of the first waveform and the second waveform inverted relative to each other, is applied to the piezoelectric element 80. This enables reduction in the influence of the noise generated by the application of the minute vibration waveform and allows accurate temperature detection.

### B. Second Embodiment

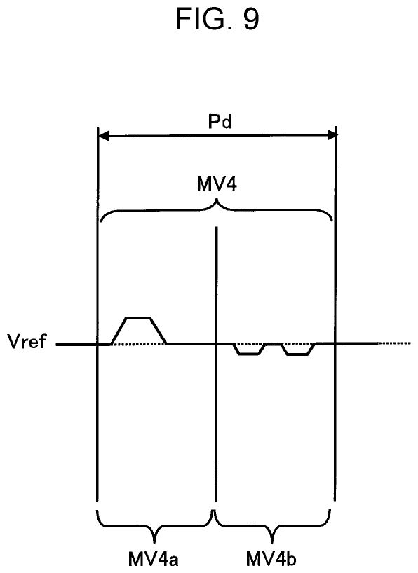

FIG. 9 is an explanatory diagram illustrating a minute vibration waveform according to the second embodiment. The apparatus configuration in the second embodiment is the same as in the first embodiment. The difference between the first and second embodiments lies only in the shape of the minute vibration waveform; other configurations and operations are substantially the same as those in the first embodiment.

The minute vibration waveform MV4 in the second embodiment consists of a first waveform MV4a with a predefined voltage change and a second waveform MV4b with a voltage change different from that of the first waveform MV4a. The first and second waveforms MV4a and MV4b are not inverted versions of each other. However, the first waveform MV4a and the second waveform MV4b are formed such that, when the minute vibration waveform MV4 is applied to a plurality of piezoelectric elements 80, an error in the detection result of the temperature detection element 301 caused by a potential change of the temperature detection element 301 due to a potential change of the first waveform MV4a is reduced by a potential change of the temperature detection element 301 due to a potential change of the second waveform MV4b. The minute vibration waveforms MV1, MV2, and MV3 in the first embodiment also exhibit this characteristic. It is preferable that the area enclosed by the reference potential Vref and the first waveform MV4a be equal to the area enclosed by the reference potential Vref and the second waveform MV4b.

Even when the minute vibration waveform MV4 in the second embodiment is used, the temperature of the head chip can be accurately detected, as is the case when the minute vibration waveform in the first embodiment is used.

### C. Third Embodiment

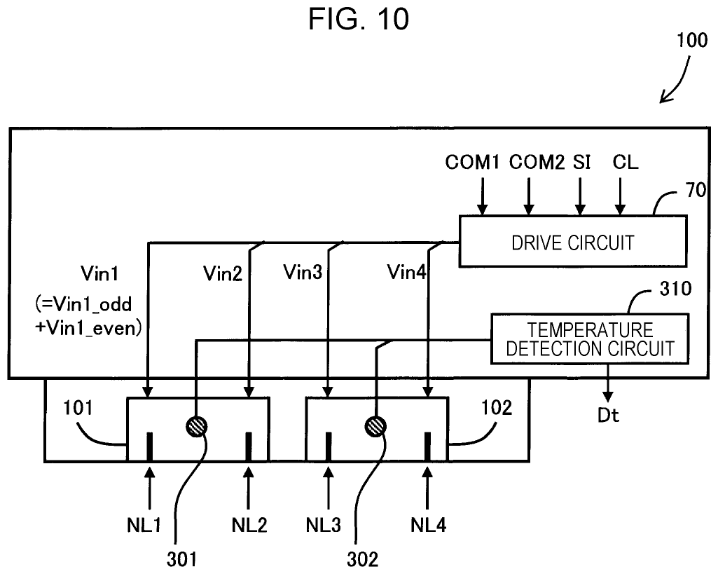

FIG. 10 is a conceptual diagram of a liquid ejecting head in a third embodiment. The main differences from the first embodiment illustrated in FIG. 5 are as follows.

(1) A drive circuit 70 is configured to generate the drive signals Vin1 to Vin4 for the individual piezoelectric elements 80 in the four nozzle rows NL1 to NL4 based on the first common drive signal COM1, the second common drive signal COM2, the dot control signal SI, and the dot clock signal CL.

(2) The temperature detection circuit 310 uses the temperature detection element 301 of the first head chip 101 and the temperature detection element 302 of the second head chip 102 to generate a temperature detection signal Dt, which indicates the average temperature of the first and second head chips 101 and 102.

The generation of the drive signal Vin for each piezoelectric element 80 by the drive circuit 70 is implemented using, for example, a supply circuit 31d illustrated in FIG. 17 of JP-A-2023-31984, disclosed by the applicant of the present disclosure.

According to the configuration in FIG. 10, the drive signal Vin having a waveform of either the first common drive signal COM1 or the second common drive signal COM2 can be arbitrarily applied to each piezoelectric element 80 of each nozzle row. The temperature detection signal Dt indicates the average temperature of the first and second head chips 101 and 102, and the drive waveform correction unit 422 corrects the drive waveform data DC1 and DC2 for the common drive signals COM1 and COM2 according to the temperature detection signal Dt.

Instead of using the average temperature of the first head chip 101 and the second head chip 102, either the detected temperature of the first head chip 101 or the detected temperature of the second head chip 102 may be used to correct the drive waveform data DC1 and DC2 of the common drive signals COM1 and COM2. For example, the detected temperature of one of the two head chips 101 and 102 that has a greater influence on the image quality of the printed material may be used to correct the drive waveform data DC1 and DC2 of the common drive signals COM1 and COM2. Such a head chip may be one that ejects ink with higher visibility or one that is used more frequently.

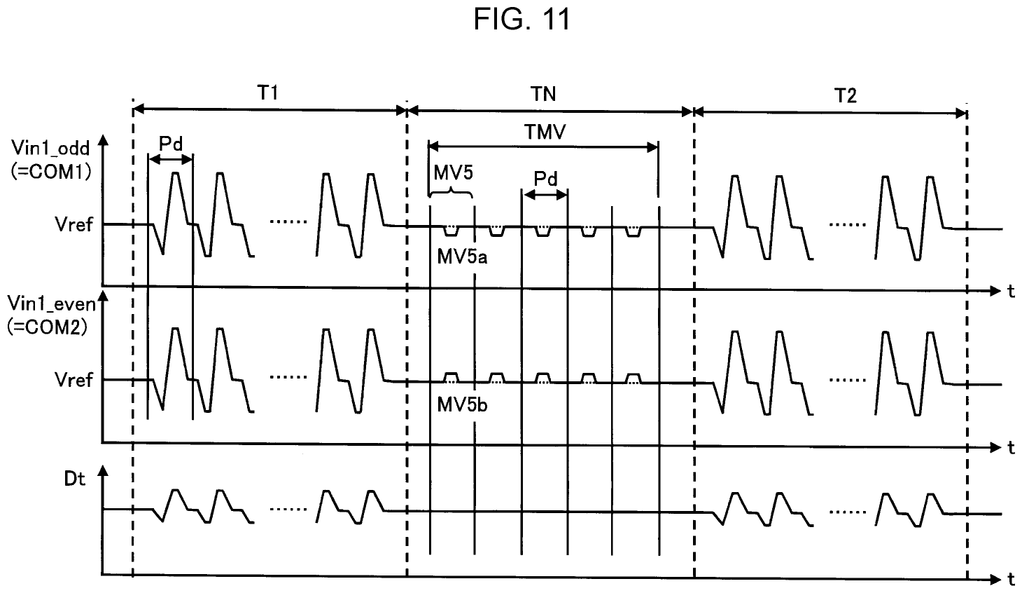

FIG. 11 is a timing chart illustrating a temperature detection method according to a third embodiment. The top portion of FIG. 11 illustrates the drive signal Vin1_odd applied to the piezoelectric elements 80 that drive the odd-numbered nozzles 200, among the drive signals Vin1 of the first head chip 101. The middle portion of FIG. 11 illustrates the drive signal Vin1_even applied to the piezoelectric elements 80 that drive the even-numbered nozzles 200, among the drive signals Vin1 of the first head chip 101. The drive signal Vin1_odd for the odd-numbered nozzles has a waveform selected from among those of the first common drive signal COM1, while the drive signal Vin1_even for the even-numbered nozzles has a waveform selected from among those of the second common drive signal COM2.

During temperature detection by the temperature detection circuit 310, a first waveform MV5a with a predefined voltage change is applied as the minute vibration waveform MV5 to a piezoelectric element group for the odd-numbered nozzles. Simultaneously, a second waveform MV5b, which is an inverted waveform of the first waveform MV5a, is applied to a piezoelectric element group for the even-numbered nozzles. In the example illustrated in FIG. 11, the first waveform MV5a changes from the reference potential Vref into a concave shape, and the second waveform MV5b changes from the reference potential Vref into a convex shape. Additionally, the first waveform MV5a and the second waveform MV5b change at the same timing and are generated such that the average voltage of the first waveform MV5a and the second waveform MV5b at any time equals the reference potential Vref.

When the minute vibration waveform MV5 in such a manner is applied to the piezoelectric elements 80, noise caused by the first waveform MV5a and noise caused by the second waveform MV5b may be introduced in the temperature detection signal Dt. However, since these noises cancel each other out, the resulting noise is substantially eliminated. Therefore, even in the third embodiment, it is possible to accurately detect the temperature of the head chip.

In the third embodiment, the inverted minute vibration waveforms are applied to the piezoelectric element groups for the odd-numbered nozzles and the even-numbered nozzles. However, the plurality of piezoelectric elements 80 included in each head chip may be classified into the first piezoelectric element group and the second piezoelectric element group using a different classification method. For example, in the first head chip 101, a first piezoelectric element group may correspond to the first nozzle row NL1 and a second piezoelectric element group may correspond to the second nozzle row NL2. The same applies to the second head chip 102. It is preferable that the number of piezoelectric elements 80 in the first piezoelectric element group be equal to the number of piezoelectric elements 80 in the second piezoelectric element group. Moreover, during temperature detection by the temperature detection circuit 310, it is preferable that the second waveform MV5b not be applied but the first waveform MV5a be applied to the first piezoelectric element group, and that the first waveform MV5a not be applied but the second waveform MV5b be applied to the second piezoelectric element group.

### D. Fourth Embodiment

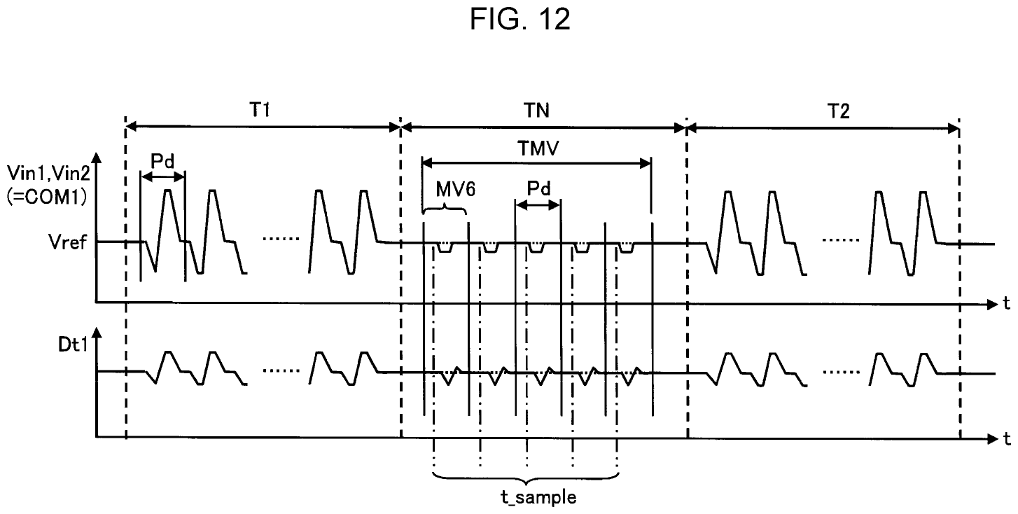

FIG. 12 is a timing chart illustrating a temperature detection method according to a fourth embodiment. The apparatus configuration in the fourth embodiment is the same as in the first embodiment. The difference between the first and fourth embodiments lies only in the shape of the minute vibration waveform and the sampling timing for temperature detection; other configurations and operations remain substantially the same.

The minute vibration waveform MV6 according to the fourth embodiment changes from the reference potential Vref into a concave shape. The sampling timing t_sample for the temperature detection is set to a time when no voltage change has occurred in the minute vibration waveform MV6. In the example illustrated in FIG. 12, the minute vibration waveform MV6 is generated regularly in each dot period Pd, and the sampling timing t_sample is also set once per dot period Pd such that the sampling timing t_sample is a timing at which no voltage change has occurred in the minute vibration waveform MV6. The sampling timing t_sample is preferably set before the voltage change of the minute vibration waveform MV6 starts in each dot period Pd. The temperature detection circuit 310 can accurately detect the temperature of the head chip without being affected by noise from the minute vibration waveform MV6.

### E. Other Aspects

The present disclosure is not limited to the embodiments described above and may be implemented in various forms without departing from the spirit and scope thereof. For example, the present disclosure may also be implemented in the following aspects. The technical features in the above-described embodiments corresponding to the technical features in each aspect described below may be appropriately replaced or combined in order to solve some or all of the problems to be solved by the present disclosure or in order to achieve some or all of the effects of the present disclosure. In addition, the technical features may be appropriately removed if they are not described in the present specification as essential elements.

(1) According to the first aspect of the present disclosure, there is provided a method for detecting a temperature of a head chip including a plurality of nozzles for ejecting liquid, a plurality of piezoelectric elements for applying pressure to the liquid in order to eject the liquid from each of the plurality of nozzles, and a temperature detection element. The method includes detecting the temperature of the head chip using the temperature detection element during a minute vibration application period in which a minute vibration waveform is applied to the plurality of piezoelectric elements. The minute vibration waveform does not cause the liquid to be ejected from the plurality of nozzles. The detecting the temperature includes generating the minute vibration waveform such that the minute vibration waveform includes a first waveform having a predefined voltage change and a second waveform that is an inverted waveform of the first waveform.

According to this method, it is possible to reduce the influence of noise caused by the application of the minute vibration waveform and to accurately perform the temperature detection.

(2) In the above method, the same minute vibration waveform may be applied to the plurality of piezoelectric elements, and the minute vibration waveform may be generated such that the first waveform and the second waveform appear sequentially without overlapping each other.

According to this method, it is possible to accurately perform temperature detection while applying the same minute vibration waveform to the plurality of piezoelectric elements.

(3) In the above method, the plurality of piezoelectric elements may be classified into a first piezoelectric element group and a second piezoelectric element group, the second waveform is not applied but the first waveform is applied to the first piezoelectric element group, and the first waveform is not applied but the second waveform is applied to the second piezoelectric element group.

According to this method, since the noise caused by the first waveform and the noise caused by the second waveform can cancel each other out, it is possible to accurately perform temperature detection.

(4) In the above method, the number of piezoelectric elements included in the first piezoelectric element group may be equal to the number of piezoelectric elements included in the second piezoelectric element group.

According to this method, the noise caused by the first waveform and the noise caused by the second waveform can efficiently cancel each other out.

(5) In the above method, the first waveform may start from a reference potential and end at the reference potential, the second waveform may start from the reference potential and end at the reference potential, and the waveform shape of the first waveform corresponding to a potential higher than or equal to the reference potential and the waveform shape of the second waveform corresponding to a potential lower than or equal to the reference potential may be symmetrical with respect to the reference potential. Likewise, the waveform shape of the first waveform corresponding to a potential lower than or equal to the reference potential and the waveform shape of the second waveform corresponding to a potential higher than or equal to the reference potential may be symmetrical with respect to the reference potential.

According to this method, the noise caused by the first waveform and the noise caused by the second waveform can efficiently cancel each other out.

(6) According to the second aspect of the present disclosure, there is provided a liquid ejecting apparatus that ejects liquid. The liquid ejecting apparatus includes: a head chip including a plurality of nozzles configured to eject the liquid, a plurality of piezoelectric elements configured to apply pressure to the liquid in order to eject the liquid from each of the plurality of nozzles, and a temperature detection element; a drive signal generator configured to generate a minute vibration waveform that does not cause the liquid to be ejected from the plurality of nozzles; a drive circuit configured to apply the minute vibration waveform to the plurality of piezoelectric elements in a minute vibration application period; and a temperature detection circuit configured to detect a temperature of the head chip using the temperature detection element during the minute vibration application period. The drive signal generator is configured to generate the minute vibration waveform such that the minute vibration waveform includes a first waveform having a predefined voltage change and a second waveform that is an inverted waveform of the first waveform.

According to the liquid ejecting apparatus, since the temperature is detected using the temperature detection element while applying the minute vibration waveform having the first waveform and the second waveform, which are inverted to each other, to the piezoelectric element, it is possible to reduce the influence of noise caused by the application of the minute vibration waveform and to accurately perform the temperature detection.

(7) According to the third aspect of the present disclosure, there is provided a method for detecting a temperature of a head chip including a plurality of nozzles for ejecting liquid, a plurality of piezoelectric elements for applying pressure to the liquid in order to eject the liquid from each of the plurality of nozzles, and a temperature detection element. The method includes detecting the temperature of the head chip using the temperature detection element during a minute vibration application period in which a minute vibration waveform is applied to the plurality of piezoelectric elements. The minute vibration waveform does not cause the liquid to be ejected from the plurality of nozzles. The detecting the temperature includes generating the minute vibration waveform such that the minute vibration waveform includes a first waveform having a predefined voltage change and a second waveform different from the first waveform. The first waveform and the second waveform are formed such that an error in a detection result of the temperature detection element due to a potential change of the temperature detection element caused by a potential change of the first waveform is reduced by a potential change of the temperature detection element caused by a potential change of the second waveform.

According to this method, it is possible to reduce the influence of noise caused by the application of the minute vibration waveform and to accurately perform the temperature detection.

(8) According to the fourth aspect of the present disclosure, there is provided a liquid ejecting apparatus that ejects liquid. The liquid ejecting apparatus includes: a head chip including a plurality of nozzles configured to eject the liquid, a plurality of piezoelectric elements configured to apply pressure to the liquid in order to eject the liquid from each of the plurality of nozzles, and a temperature detection element; a drive signal generator configured to generate a minute vibration waveform that does not cause the liquid to be ejected from the plurality of nozzles; a drive circuit configured to apply the minute vibration waveform to the plurality of piezoelectric elements in a minute vibration application period; and a temperature detection circuit configured to detect a temperature of the head chip using the temperature detection element during the minute vibration application period. The drive signal generator is configured to generate the minute vibration waveform such that the minute vibration waveform includes a first waveform having a predefined voltage change and a second waveform different from the first waveform. The first waveform and the second waveform are formed such that an error in a detection result of the temperature detection element due to a potential change of the temperature detection element caused by a potential change of the first waveform is reduced by a potential change of the temperature detection element caused by a potential change of the second waveform.

According to the liquid ejecting apparatus, it is possible to suppress the influence of noise caused by the application of the minute vibration waveform and to accurately perform the temperature detection.

The present disclosure may be implemented in various forms other than the method for detecting the temperature of a head chip and the liquid ejecting apparatus. For example, the present disclosure may be implemented in the forms of a method for correcting a common drive signal, a method for controlling a liquid ejecting apparatus, a computer program for implementing the method, a non-transitory recording medium on which the computer program is recorded, and so on.

What is claimed is:

1. A method for detecting a temperature of a head chip including a plurality of nozzles for ejecting liquid, a plurality of piezoelectric elements that is configured to apply pressure to the liquid in order to eject the liquid from each of the plurality of nozzles, and a temperature detection element, the method comprising:
detecting the temperature of the head chip using the temperature detection element during a minute vibration application period in which a minute vibration waveform is applied to the plurality of piezoelectric elements, the minute vibration waveform not causing the liquid to be ejected from the plurality of nozzles, wherein
the detecting the temperature includes generating the minute vibration waveform such that the minute vibration waveform includes a first waveform having a predefined voltage change and a second waveform that is an inverted waveform of the first waveform.

2. The method according to claim 1, wherein
the same minute vibration waveform is applied to the plurality of piezoelectric elements, and
the minute vibration waveform is generated such that the first waveform and the second waveform appear sequentially without overlapping each other.

3. The method according to claim 1, wherein
the plurality of piezoelectric elements are classified into a first piezoelectric element group and a second piezoelectric element group, and
the second waveform is not applied but the first waveform is applied to the first piezoelectric element group, and the first waveform is not applied but the second waveform is applied to the second piezoelectric element group.

4. The method according to claim 3, wherein
a number of piezoelectric elements included in the first piezoelectric element group is equal to a number of piezoelectric elements included in the second piezoelectric element group.

5. The method according to claim 1, wherein
the first waveform starts from a reference potential and ends at the reference potential,
the second waveform starts at the reference potential and ends at the reference potential,
a waveform shape of the first waveform corresponding to a potential higher than or equal to the reference potential and a waveform shape of the second waveform corresponding to a potential lower than or equal to the reference potential are symmetrical with respect to the reference potential, and
a waveform shape of the first waveform corresponding to a potential lower than or equal to the reference potential and a waveform shape of the second waveform corresponding to a potential higher than or equal to the reference potential are symmetrical with respect to the reference potential.

6. A liquid ejecting apparatus that ejects liquid, comprising:
a head chip including a plurality of nozzles configured to eject the liquid, a plurality of piezoelectric elements configured to apply pressure to the liquid in order to eject the liquid from each of the plurality of nozzles, and a temperature detection element;
a drive signal generator configured to generate a minute vibration waveform that does not cause the liquid to be ejected from the plurality of nozzles;
a drive circuit configured to apply the minute vibration waveform to the plurality of piezoelectric elements in a minute vibration application period; and
a temperature detection circuit configured to detect a temperature of the head chip using the temperature detection element during the minute vibration application period, wherein
the drive signal generator is configured to generate the minute vibration waveform such that the minute vibration waveform includes a first waveform having a predefined voltage change and a second waveform that is an inverted waveform of the first waveform.

7. A method for detecting a temperature of a head chip including a plurality of nozzles for ejecting liquid, a plurality of piezoelectric elements that is configured to apply pressure to the liquid in order to eject the liquid from the plurality of nozzles, and a temperature detection element, the method comprising:
detecting the temperature of the head chip using the temperature detection element during a minute vibration application period in which a minute vibration waveform is applied to the plurality of piezoelectric elements, the minute vibration waveform not causing the liquid to be ejected from the plurality of nozzles, wherein
the detecting the temperature includes generating the minute vibration waveform such that the minute vibration waveform includes a first waveform having a predefined voltage change and a second waveform different from the first waveform, and
the first waveform and the second waveform are formed such that an error in a detection result of the temperature detection element caused by a potential change of the temperature detection element due to a potential change of the first waveform is reduced by a potential change of the temperature detection element due to a potential change of the second waveform.

8. A liquid ejecting apparatus that ejects liquid, comprising:
a head chip including a plurality of nozzles configured to eject the liquid, a plurality of piezoelectric elements configured to apply pressure to the liquid in order to eject the liquid from each of the plurality of nozzles, and a temperature detection element;
a drive signal generator configured to generate a minute vibration waveform that does not cause the liquid to be ejected from the plurality of nozzles;
a drive circuit configured to apply the minute vibration waveform to the plurality of piezoelectric elements in a minute vibration application period; and
a temperature detection circuit configured to detect a temperature of the head chip using the temperature detection element during the minute vibration application period, wherein
the drive signal generator is configured to generate the minute vibration waveform such that the minute vibration waveform includes a first waveform having a predefined voltage change and a second waveform different from the first waveform, and
the first waveform and the second waveform are formed such that an error in a detection result of the temperature detection element caused by a potential change of the temperature detection element due to a potential change of the first waveform is reduced by a potential change of the temperature detection element due to a potential change of the second waveform.
